(19) United States
(12) Patent Application Publication
(10) Pub. No.: US 2026/0052348 A1
(43) Pub. Date: Feb. 19, 2026

(54) LOUDSPEAKER, LOUDSPEAKER MODULE AND ELECTRONIC DEVICE

(71) Applicant: MERRY ELECTRONICS (SUZHOU) CO., LTD., Suzhou City (CN)

(72) Inventors: Chunlong ZHENG, Suzhou City (CN); Mingya LUO, Suzhou City (CN)

(73) Assignee: MERRY ELECTRONICS (SUZHOU) CO., LTD., Suzhou City (CN)

(21) Appl. No.: 18/929,225

(22) Filed: Oct. 28, 2024

(30) Foreign Application Priority Data
Aug. 19, 2024 (CN) 202411133460.1

(51) Int. Cl. H04R 17/00; H04R 1/02; H04R 7/04; H04R 7/18

(52) U.S. Cl. CPC H04R 17/00; H04R 1/025; H04R 7/04; H04R 7/18; H04R 2400/11

(57) ABSTRACT

A loudspeaker includes a support frame, a diaphragm assembly, a first piezoelectric cantilever, a connecting member, and a support member. The first piezoelectric cantilever includes a first fixed end connected to the support frame and a first free end suspended inside the support frame; a first end of the connecting member is connected to the first free end, the other end of the connecting member extends in a direction facing away from the first free end, and a stiffness of the connecting member is less than a stiffness of the first piezoelectric cantilever; the support member is connected to the connecting member and is used for being connected to the diaphragm assembly of the loudspeaker, and a position where the support member is connected to the connecting member is spaced from a position where the connecting member is connected to the first free end.

### CROSS-REFERENCE TO RELATED APPLICATION(S)

This application claims the priority of a Chinese Patent Application No. 202411133460.1, filed on Aug. 19, 2024, the disclosure of which is incorporated herein by reference in its entirety.

### TECHNICAL FIELD

The present disclosure relates to the field of loudspeakers and, in particular, to a loudspeaker, a loudspeaker module and an electronic device.

### BACKGROUND

A loudspeaker, as an important electro-acoustic device, has been widely used in an electronic device. The loudspeaker is divided into a moving-coil loudspeaker, a moving-iron loudspeaker, and a piezoelectric loudspeaker according to the type of technology. The piezoelectric loudspeaker has the advantages of being small, thin, lightweight, and free of magnetic field interference compared to the moving-coil loudspeaker.

In the related art, the piezoelectric loudspeaker includes a piezoelectric plate and a diaphragm stacked with the piezoelectric plate. The piezoelectric plate vibrates under a drive voltage to drive the diaphragm to vibrate, thereby enabling the loudspeaker to generate sound. A support block is generally disposed between the piezoelectric plate and the diaphragm. The piezoelectric plate is a cantilever beam structure, and the support block is directly disposed on the free end of the piezoelectric plate. Since the piezoelectric plate generally includes a substrate and a piezoelectric driver disposed on the substrate, the stiffness of the piezoelectric plate is large. When the piezoelectric plate directly drives the diaphragm to vibrate through the support block, the diaphragm is prone to damage, thereby making the piezoelectric loudspeaker have low reliability and a short service life.

Therefore, a highly reliable loudspeaker, loudspeaker module and electronic device are urgently needed.

### SUMMARY

Embodiments of the present disclosure provide a loudspeaker, a loudspeaker module and an electronic device.

The loudspeaker includes a support frame, a diaphragm assembly, a first piezoelectric cantilever, a connecting member, and a support member.

The periphery of the diaphragm assembly is fixedly connected to the support frame.

The first piezoelectric cantilever includes a first fixed end and a first free end. The first fixed end is connected to the support frame, and the first free end is suspended inside the support frame.

A first end of the connecting member is connected to the first free end, and the other end of the connecting member extends in a direction facing away from the first free end. The stiffness of the connecting member is less than the stiffness of the first piezoelectric cantilever.

The support member is connected to the connecting member and is used for being connected to the diaphragm assembly. The position where the support member is connected to the connecting member is spaced from the position where the connecting member is connected to the first free end.

In some embodiments, the loudspeaker further includes a second piezoelectric cantilever. The second piezoelectric cantilever is disposed at the same layer as the first piezoelectric cantilever and includes a second fixed end and a second free end. The second fixed end is connected to the support frame, and the second free end is suspended inside the support frame and spaced from the first free end.

A second end of the connecting member, disposed opposite to the first end is connected to the second free end. The position where the connecting member is connected to the second piezoelectric cantilever is spaced from the position where the support member is connected to the connecting member.

The stiffness of the connecting member is less than the stiffness of the second piezoelectric cantilever.

In some embodiments, the first piezoelectric cantilever and the second piezoelectric cantilever are spaced in a first direction. The support member is located between the first piezoelectric cantilever and the second piezoelectric cantilever in the first direction.

In some embodiments, one support member is provided in the loudspeaker. The minimum distance between the support member and the first piezoelectric cantilever in the first direction is equal to the minimum distance between the support member and the second piezoelectric cantilever in the first direction.

In some embodiments, multiple support members are provided in the loudspeaker. The multiple support members are spaced in the first direction.

In some embodiments, the thickness direction of the connecting member is the same as the thickness direction of the first piezoelectric cantilever. One side of the connecting member in the thickness direction is connected to the first free end, and the thickness of the connecting member is less than the thickness of the first piezoelectric cantilever.

In some embodiments, the length of the connecting member in a second direction is equal to or less than the length of the first piezoelectric cantilever in the second direction.

In some embodiments, the connecting member is connected to the surface of the first piezoelectric cantilever facing the diaphragm assembly.

In some embodiments, a protrusion is disposed on the surface of the diaphragm assembly facing the first piezoelectric cantilever, and an avoidance structure matching the protrusion is disposed on the surface of the support member facing the diaphragm assembly. The avoidance structure is used for avoiding the protrusion.

The loudspeaker module includes a housing and the loudspeaker described above. The housing is provided with a sound outlet hole. The sound outlet hole enables the internal space of the housing to be in communication with the external space of the housing. The loudspeaker is mounted in the internal space of the housing.

The electronic device includes the loudspeaker described above or the loudspeaker module described above.

### BRIEF DESCRIPTION OF DRAWINGS

To illustrate the solutions in embodiments of the present disclosure more clearly, the drawings used in the description of the embodiments herein are briefly described below. Apparently, the drawings described below only illustrate part of the embodiments of the present disclosure, and those of ordinary skill in the art may obtain other drawings based on the content of the embodiments herein and the drawings herein on the premise that no creative work is done.

FIG. 1 is a structure view of a loudspeaker according to one or more embodiments of the present disclosure;

FIG. 2 is an exploded view of a loudspeaker according to one or more embodiments of the present disclosure;

FIG. 3 is a structure view of part of a loudspeaker according to one or more embodiments of the present disclosure;

FIG. 4 is an exploded view of part of a loudspeaker according to one or more embodiments of the present disclosure;

FIG. 5 is an exploded view of a first piezoelectric cantilever according to one or more embodiments of the present disclosure;

FIG. 6 is a top view of a loudspeaker according to one or more embodiments of the present disclosure;

FIG. 7 is a section view taken along A-A in FIG. 6 in the present disclosure; and

FIG. 8 is a section view taken along B-B in FIG. 6 in the present disclosure.

### REFERENCE LIST

100 support frame
110 frame
120 circuit board
200 first piezoelectric cantilever
210 first fixed end
220 first free end
230 cantilever beam
240 driver
300 connecting member
400 support member
410 avoidance structure
500 second piezoelectric cantilever
510 second fixed end
520 second free end
600 diaphragm assembly
610 protrusion
620 first diaphragm assembly
630 second diaphragm assembly
X first direction
Y second direction

### DETAILED DESCRIPTION

To make the problems to be solved, the solutions to be adopted and the effects to be achieved in the present disclosure clearer, the solutions of the present disclosure will be further described hereinafter in conjunction with drawings and embodiments. It is to be understood that the embodiments described herein are intended to illustrate and not to limit the present disclosure. In addition, it is to be further noted that, for ease of description, only part, not all, related to the present disclosure is illustrated in the drawings.

It is to be noted that similar reference numerals and letters represent similar items in the following drawings, and therefore, once a particular item is defined in a drawing, the item needs not to be further defined and explained in the following drawings.

In the description of the present disclosure, unless otherwise clearly specified and defined, the terms “connected to each other”, “connected” or “secured” is to be understood in a broad sense, for example, as “securely connected”, “detachably connected” or “integrated”; “mechanically connected” or “electrically connected”; “directly connected to each other” or “indirectly connected to each other via an intermediary”; or “internally connected between two components” or “interaction relation between two components”. For those of ordinary skill in the art, specific meanings of the preceding terms in the present disclosure may be understood based on specific situations.

In the present disclosure, unless otherwise clearly specified and defined, when a first feature is described as “above” or “below” a second feature, the first feature and the second feature may be in direct contact or may be in contact via another feature between the two features instead of being in direct contact. Moreover, the first feature being “on”, “above” or “over” the second feature includes that the first feature is right or obliquely above the second feature or simply means that the first feature is at a higher level than the second feature. The first feature being “under”, “below” or “underneath” the second feature includes that the first feature is right or obliquely below the second feature or simply means that the first feature is at a lower level than the second feature. In the description of the embodiments, unless otherwise noted, “multiple” or “a plurality of” specifically means two or more.

In the description of the embodiments, the orientation or position relationships indicated by the terms “above”, “below”, “right”, and the like are based on the orientation or position relationships shown in the drawings, merely for facilitating the description and simplifying operations, and do not indicate or imply that the apparatus or element referred to must have a specific orientation and must be constructed and operated in a specific orientation, and thus it is not to be construed as limiting the present disclosure. Moreover, the terms “first” and “second” are merely used for descriptive purposes and have no special meanings.

It is to be noted that when an element is described as being “fixed to” or “disposed on” another element, it may be directly on the particular element or intervening elements may be on the particular element.

One or more embodiments of present disclosure provide a loudspeaker which can reduce the probability of damage to the diaphragm assembly and has high reliability and a long service life.

The loudspeaker in the embodiments may be a micro-electromechanical system (MEMS) loudspeaker. The MEMS loudspeakers can be widely used in current mobile electronic devices, such as mobile phones and smart wearable devices, due to their advantages of low power consumption and lightweight.

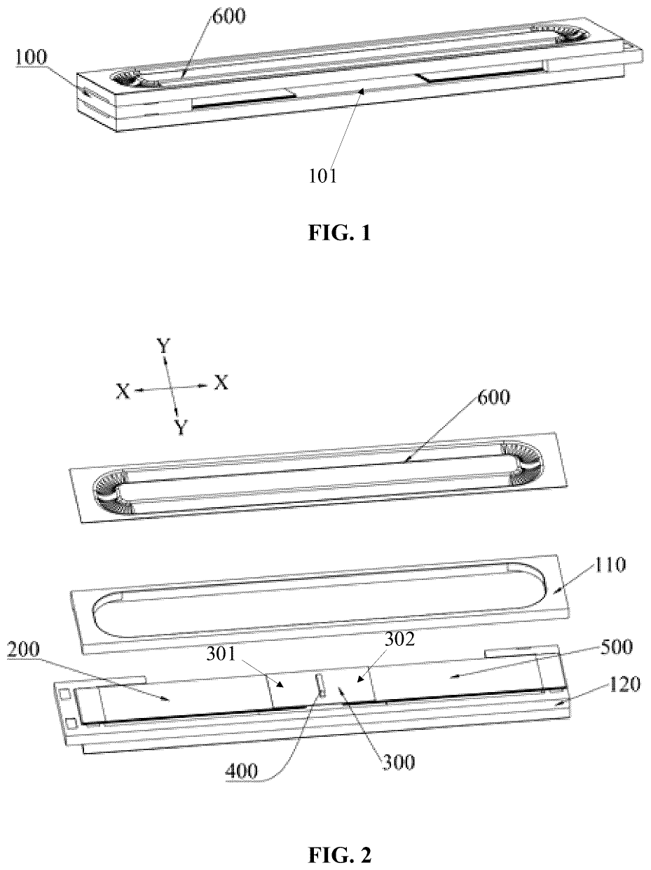

In some embodiments, as shown in FIGS. 1 to 8, the loudspeaker includes a support frame 100, a first piezoelectric cantilever 200, a connecting member 300, and a support member 400.

For example, the support frame 100 is made of a hard material such as metal, plastic, and the like.

For example, the support frame 100 has a frame structure, and the support frame 100 has a cavity 101 running through both surfaces of the support frame 100 in the thickness direction thereof. The support frame 100 may be a separate member, or, the support frame 100 may also be an integral member. For example, as shown in FIG. 2, the support frame 100 includes a frame 110 and a circuit board 120 disposed on the frame 110. The cavity is provided through the frame 110 and the circuit board 120. The circuit board 120 is used for being electrically connected to the first piezoelectric cantilever 200 to supply an acousto-electric signal to the first piezoelectric cantilever 200.

For example, the circuit board 120 may be provided with a weld disc, and the first piezoelectric cantilever 200 is welded to the weld disc to achieve the electrical connection between the circuit board 120 and the first piezoelectric cantilever 200.

In some optional embodiments, one end of the first piezoelectric cantilever 200 is sandwiched between the circuit board 120 and the frame 110 to improve the fixation of the first piezoelectric cantilever 200 on the support frame 100.

As shown in FIG. 4, the first piezoelectric cantilever 200 includes a first fixed end 210 and a first free end 220. The first fixed end 210 is connected to the support frame 100. For example, the first fixed end 210 is sandwiched between the circuit board 120 and the frame 110. The first free end 220 is suspended inside the support frame 100. For example, the first free end 220 is suspended in a side of the cavity of the support frame 100 so that the first free end 220 can vibrate in the cavity. For example, the first fixed end 210 and the first free end 220 are two opposite ends of the first piezoelectric cantilever 200.

For example, as shown in FIG. 2, a first end 301 of the connecting member 300 is connected to the first free end 220 of the first piezoelectric cantilever 200. The manner of connecting the connecting member 300 to the first free end 220 includes, but is not limited to, bonding, welding, and the like. The stiffness of the connecting member 300 is less than the stiffness of the second piezoelectric cantilever 200.

It is to be noted that the stiffness refers to the ability of a material or structure to resist elastic deformation in response to an applied force. The greater the stiffness of a structure is, the higher of the ability of the structure to resist elastic deformation in response to an applied force is, and the less elastic the structure is. In one or more embodiments, the stiffness of the first piezoelectric cantilever 200 is greater than the stiffness of the connecting member 300, that is, the rigidity of the first piezoelectric cantilever 200 is greater than the rigidity of the connecting member 300, so that the elasticity of the connecting member 300 is greater than the elasticity of the first piezoelectric cantilever 200.

It is further to be noted that the stiffness of the connecting member 300 in the vibration direction of the first piezoelectric cantilever 200 is less than the stiffness of the first piezoelectric cantilever 200 in its vibration direction. For example, the vibration direction of the first piezoelectric cantilever 200 may be the thickness direction of the first piezoelectric cantilever 200.

For example, the material of the connecting member 300 includes, but is not limited to, a metal material, a polymer material, and the like, as long as the best performance can be achieved. For example, the material of the connecting member 300 is polyimide (PI).

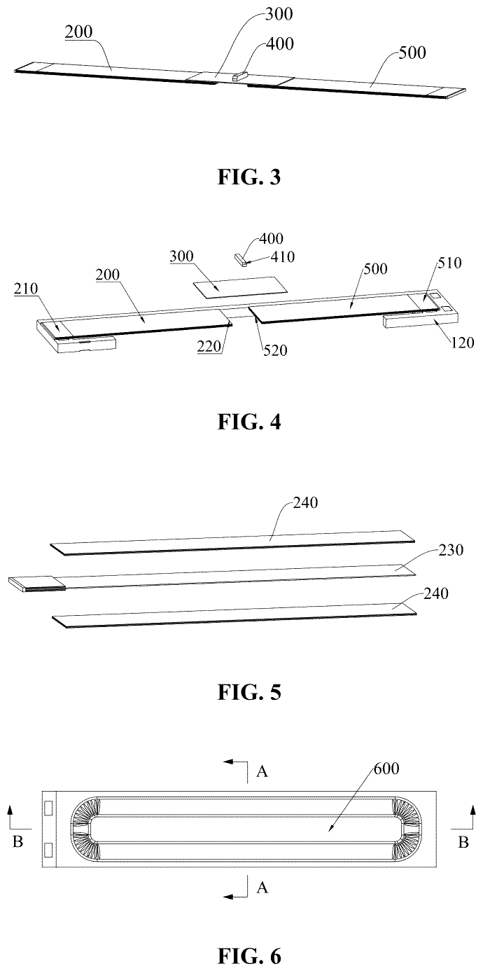

For example, as shown in FIG. 3, the support member 400 is connected to the connecting member 300, that is, the support member 400 is not directly connected to the first piezoelectric cantilever 200, but is connected to the connecting member 300. The support member 400 is used for being connected to the diaphragm assembly 600 of the loudspeaker to transmit vibrations to the diaphragm assembly 600 and to support the connecting member 300, thereby achieving support for the first piezoelectric cantilever 200.

For example, the support member 400 is made of a hard material such as metal, plastic, and the like to enable the transmission of power and motion to be efficient and accurate. The support member 400 may be made of a lightweight material such as lightweight metal and the like to reduce the resistance of transmission and improve the sensitivity of the transmission of power and motion.

In one or more embodiments, the position where the support member 400 is connected to the connecting member 300 is spaced from the position where the connecting member 300 is connected to the first free end 220, that is, the position where the support member 400 is connected to the first piezoelectric cantilever 200 is different from the position where the connecting member 300 is connected to the support member 400. The position where the support member 400 is connected to the connecting member 300 is named a first connection position, the position where the connecting member 300 is connected to the first free end 220 is named a second connection position, and a certain distance exists between the first connection position and the second connection position. For example, a segment of the connecting member 300 is between the first connection position and the second connection position.

In the loudspeaker provided in one or more embodiments, the first free end 220 of the first piezoelectric cantilever 200 is connected to the connecting member 300, and the stiffness of the connecting member 300 is less than the stiffness of the first piezoelectric cantilever 200. The support member 400 is connected to the connecting member 300, and the support member 400 is used for connecting the connecting member 300 to the diaphragm assembly 600 of the loudspeaker to transmit power. The position where the support member 400 is connected to the connecting member 300 is spaced from the position where the connecting member 300 is connected to the first free end 220 so that the first free end 220 of the first piezoelectric cantilever 200 is not directly connected to the support member 400, but is connected to the support member 400 through the connecting member 300. The stiffness of the connecting member 300 is less than the stiffness of the first piezoelectric cantilever 200 so that the connecting member 300 has a certain degree of elasticity compared to the first piezoelectric cantilever 200. The connecting member 300 can prevent the amplitude of the diaphragm assembly 600 from a drastic change in a short period of time so that the diaphragm assembly 600 is not prone to damage when the connecting member 300 drives the diaphragm assembly 600 to vibrate through the support member 400, thereby improving the reliability of the loudspeaker and prolonging the service life of the loudspeaker.

In some optional embodiments, the other end of the connecting member 300 extends in a direction facing away from the first free end 220, that is, the connecting member 300 has a portion disposed outside the first piezoelectric cantilever 200. The support member 400 may be connected to the portion of the connecting member 300 disposed outside the first piezoelectric cantilever 200 so that the distance between the support member 400 and the first free end 220 can be larger, thereby fully utilizing the flexibility of the connecting member 300.

In other optional embodiments, the connecting member 300 includes a portion which is disposed above or below the first free end 220 and is disposed opposite to the first free end 220. For example, the connecting member 300 is L-shaped, and the support member 400 may be connected to the portion, disposed opposite to the first free end 220, of the connecting member 300. When the first free end 220 vibrates, a drive force can be transmitted to the connecting member 300 and the support member 400 in sequence.

Optionally, as shown in FIG. 2, the loudspeaker further includes a second piezoelectric cantilever 500. The second piezoelectric cantilever 500 is disposed at the same layer as the first piezoelectric cantilever 200. For example, the minimum distance between the second piezoelectric cantilever 500 and the diaphragm assembly 600 is equal to the minimum distance between the first piezoelectric cantilever 200 and the diaphragm assembly 600. By setting the second piezoelectric cantilever 500, the driving area of the diaphragm assembly 600 is increased, thereby improving the sensitivity of the loudspeaker and enhancing the acoustic performance of the loudspeaker.

For example, the second piezoelectric cantilever 500 is identical or similar to the first piezoelectric cantilever 200 to achieve weight equalization of the various regions of the loudspeaker.

In some optional embodiments, the first piezoelectric cantilever 200 and the second piezoelectric cantilever 500 are symmetrically disposed, thereby reducing the overall vibration amplitude of the loudspeaker and improving the vibration stability of the loudspeaker.

For example, as shown in FIG. 4, the second piezoelectric cantilever 500 includes a second fixed end 510 and a second free end 520. For example, the second fixed end 510 and the second free end 520 are two opposite ends of the second piezoelectric cantilever 500. The second fixed end 510 is connected to the support frame 100, and the second free end 520 is suspended inside the support frame 100. For example, the second free end 520 is suspended in a side of the cavity of the support frame 100 so that the second free end 220 can have sufficient vibration space.

In one or more embodiments, the second free end 520 is spaced from the first free end 220 to prevent the first free end 220 and the second free end 520 from interfering with each other during vibration, thereby improving feasibility.

It is to be noted that the first free end 220 and the second free end 520 vibrate in the same direction, that is, the first free end 220 and the second free end 520 vibrate synchronously in the same direction, so that the first free end 220 and the second free end 520 can drive the connecting member 300 to move close to or away from the diaphragm assembly 600, and thus, the diaphragm assembly 600 is driven to move through the support member 400.

For example, as shown in FIG. 3, a second end 302 of the connecting member 300, disposed opposite to the first end, of the connecting member 300 is connected to the second free end 520. By connecting the first end and the second end of the connecting member 300 to the first free end 220 and the second free end 520, respectively, the length of the connecting member 300 can be shorter, and thus, the weight of the loudspeaker can be lower.

Optionally, the position where the connecting member 300 is connected to the second piezoelectric cantilever 500 is spaced from the position where the support member 400 is connected to the connecting member 300 so that a segment of the connecting member 300 is between the position where the connecting member 300 is connected to the second piezoelectric cantilever 500 and the position where the support member 400 is connected to the connecting member 300. Therefore, the second piezoelectric cantilever 500 is not directly connected to the support member 400, but is connected to the support member 400 through the connecting member 300, and the force of the second free end 520 is transmitted to the diaphragm assembly 600 through the connecting member 300 and the support member 400.

Further, optionally, the stiffness of the connecting member 300 is less than the stiffness of the second piezoelectric cantilever 500. When the second free end 520 drives the connecting member 300 to vibrate, the connecting member 300 drives the diaphragm assembly 600 to vibrate through the support member 400, thereby reducing the probability of damage to the diaphragm assembly 600 due to drastic changes and further improving the reliability.

Optionally, as shown in FIG. 2 or FIG. 8, the first piezoelectric cantilever 200 and the second piezoelectric cantilever 500 are spaced in a first direction X, and the support member 400 is located between the first piezoelectric cantilever 200 and the second piezoelectric cantilever 500 in the first direction X so that the support member 400 can be farther away from the position where the connecting member 300 is connected to the first free end 220 and the position where the connecting member 300 is connected to the second free end 520, thereby fully utilizing the flexibility of the connecting member 300.

It is of course to be understood that the first piezoelectric cantilever 200 and the second piezoelectric cantilever 500 may not be spaced in the first direction X, but have staggered portions in the second direction Y For example, the first free end 220 and the second free end 520 are spaced in the second direction Y so that both the first piezoelectric cantilever 200 and the second piezoelectric cantilever 500 can be longer, thereby improving the low-frequency sensitivity of the loudspeaker and further enhancing the acoustic performance of the loudspeaker.

The second direction Y is perpendicular to the first direction X. For example, the first direction X is the length direction of the loudspeaker, and the second direction Y is the width direction of the loudspeaker.

In some optional embodiments, as shown in FIG. 4, one support member 400 is disposed in the loudspeaker. The minimum distance between the support member 400 and the first piezoelectric cantilever 200 in the first direction X is equal to the minimum distance between the support member 400 and the second piezoelectric cantilever 500 in the first direction X, that is, the support member 400 is located in the middle between the first piezoelectric cantilever 200 and the second piezoelectric cantilever 500, to allow the drive forces of the first free end 220 and the second free end 520 to be transmitted to the support member 400 simultaneously, thereby improving the effectiveness of driving the diaphragm assembly 600 to vibrate.

In some other optional embodiments, multiple support members 400 are disposed in the loudspeaker, and the multiple support members 400 are spaced in the first direction X. By setting multiple support members 400, the diaphragm assembly 600 may have multiple drive points, thereby further ensuring the driving effectiveness on the diaphragm assembly 600.

For example, in the first direction X, the multiple support members 400 may all be disposed between the first piezoelectric cantilever 200 and the second piezoelectric cantilever 500, that is, the orthographic projections of the support members 400 in the plane where the first piezoelectric cantilever 200 and the second piezoelectric cantilever 500 are located do not overlap the first piezoelectric cantilever 200 and the second piezoelectric cantilever 500, thereby fully utilizing the elasticity of the connecting member 300.

Further, for example, in the first direction X, the multiple support members 400 may also include a support member 400 disposed above or below the first piezoelectric cantilever 200 and/or the second piezoelectric cantilever 500, and the support member 400 is spaced from the first piezoelectric cantilever 200 and the second piezoelectric cantilever 500 through the connecting member 300, thereby fully utilizing the elasticity of the connecting member 300.

In some optional embodiments, two support members 400 are disposed in the loudspeaker. One support member 400 is disposed close to the first free end 220 in the first direction X, and the other support member 400 is disposed close to the second free end 520 in the first direction X. The distance between one support member 400 and the edge of the first free end 220 facing the second free end 520 is equal to the distance between the other support member 400 and the edge of the second free end 520 facing the first free end 220 so that the two support members 400 can vibrate synchronously in the same direction, thereby ensuring the reliability of driving the diaphragm assembly 600.

For example, as shown in FIG. 3, the thickness direction of the connecting member 300 is the same as the thickness direction of the first piezoelectric cantilever 200. For example, the connecting member 300 and the first piezoelectric cantilever 200 are both plate-shaped, and the connecting member 300 is disposed parallel to the first piezoelectric cantilever 200.

In one or more embodiments, one side of the connecting member 300 in the thickness direction is connected to the first free end 220 so that the connecting member 300 and the first free end 220 have a large connection area, thereby improving the connection reliability of the two.

Further, the thickness of the connecting member 300 is less than the thickness of the first piezoelectric cantilever 200, thereby, in one aspect, improving the elasticity of the connecting member 300, and in another aspect, making the loudspeaker lightweight and miniaturized. It is to be noted that the thickness of the first piezoelectric cantilever 200 is equal to the thickness of the second piezoelectric cantilever 500. It is further to be noted that the first piezoelectric cantilever 200 and the second piezoelectric cantilever 500 are both of equal thickness, thereby facilitating the control of vibration.

For example, as shown in FIG. 2, the length of the connecting member 300 in a second direction Y (that is, the width of the connecting member 300) is equal to or less than the length of the first piezoelectric cantilever 200 in the second direction Y (that is, the width of the first piezoelectric cantilever 200) so that the connecting member 300 does not have a portion in the second direction Y that extends out of the first piezoelectric cantilever 200, thereby reducing energy loss. It is to be noted that the connecting member 300 and the first piezoelectric cantilever 200 are both of equal width and have regular shapes, thereby facilitating the control of vibration.

Similarly, the length of the connecting member 300 in the second direction Y is less than or equal to the length of the second piezoelectric cantilever 500 in the second direction Y.

For example, the length of the support member 400 in the second direction Y is less than or equal to the length of the connecting member 300 in the second direction Y, which is not limited herein. As shown in FIG. 2, the length of the support member 400 in the second direction Y is less than the length of the connecting member 300 in the second direction Y However, the support member 400 should not be too short, and otherwise, the effectiveness and accuracy of the transmission of the drive force will be affected.

Optionally, as shown in FIG. 2, when the loudspeaker further includes the diaphragm assembly 600, the diaphragm assembly 600 is disposed on one side of the first piezoelectric cantilever 200 in the thickness direction, specifically on the side of the first piezoelectric cantilever 200 facing away from the cavity, and the connecting member 300 is connected to the surface of the first piezoelectric cantilever 200 facing the diaphragm assembly 600. Since the amplitude of the connecting member 300 is great when the connecting member 300 vibrates towards the diaphragm assembly 600, by setting the connecting member 300 to be connected to the surface, facing the diaphragm assembly 600, of the first piezoelectric cantilever 200, the probability that the connecting member 300 fails to be connected to the first piezoelectric cantilever 200 can be reduced, thereby improving the connection stability.

Similarly, the connecting member 300 is connected to the surface of the second piezoelectric cantilever 500 facing the diaphragm assembly 600, thereby reducing the probability that the connecting member 300 fails to be connected to the second piezoelectric cantilever 500.

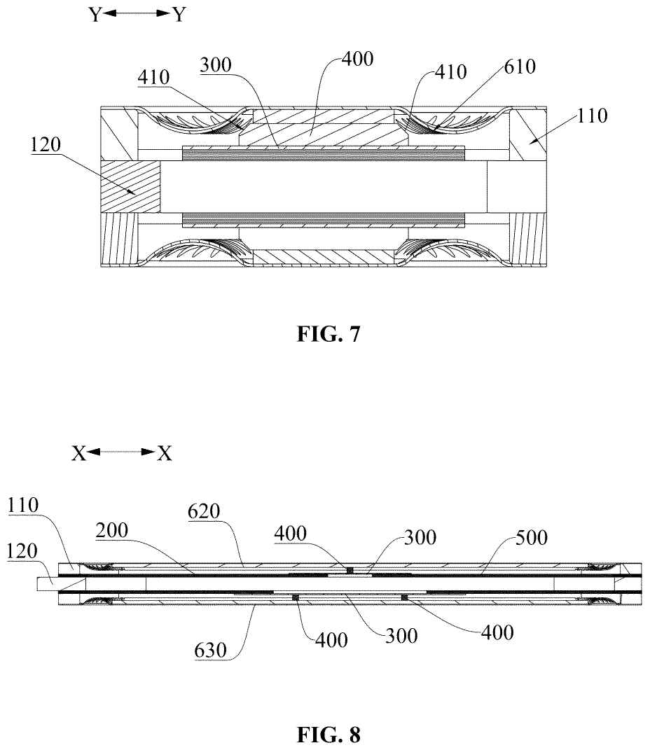

For example, as shown in FIG. 7, a protrusion 610 is disposed on the surface of the diaphragm assembly 600 facing the first piezoelectric cantilever 200, and an avoidance structure 410 which matches the protrusion 610 is disposed on the surface of the support member 400 facing the diaphragm assembly 600. The avoidance structure 410 is used for avoiding the protrusion 610 to prevent the support member 400 from colliding with the diaphragm assembly 600 when the support member 400 vibrates, thereby further improving the reliability of the loudspeaker.

For example, the diaphragm assembly 600 includes a diaphragm, and the protrusion 610 is an annular protruding structure on the diaphragm.

Further, for example, the avoidance structure 410 may be an avoidance groove, an avoidance opening, an avoidance bevel or the like, which is not limited herein. As shown in FIG. 4, the avoidance structure 410 in one or more embodiments is an avoidance bevel, and the space above the avoidance bevel may be used for accommodating the protrusion 610.

It is to be noted that when the protrusion 610 is an annular protruding structure, two avoidance structures 410 are correspondingly disposed.

Optionally, as shown in FIG. 5, the first piezoelectric cantilever 200 (or the second piezoelectric cantilever 500) may include a driver 240 and a cantilever beam 230. One end of the cantilever beam 230 is connected to the support frame 100, and the other end of the cantilever beam 230 is suspended inside the support frame 100 and is a free end. The driver 240 is connected to the cantilever beam 230. The driver 240 may be disposed above and/or below the cantilever beam 230. The area of the driver 240 may be equal to the area of the cantilever beam 230 or may be less than the area of the cantilever beam 230. The driver 240 may drive the cantilever beam 230 to vibrate in the thickness direction of the first piezoelectric cantilever 200. For example, the driver 240 may be any of a piezoelectric driver, an electrostatic driver, an electromagnetic driver or a thermoelectric driver.

In some other optional embodiments, as shown in FIGS. 7 and 8, two diaphragm assemblies 600 are disposed in the loudspeaker, that is, the loudspeaker in one or more embodiments is a dual-diaphragm loudspeaker. The two diaphragm assemblies 600 are disposed opposite on opposite side surfaces on the support frame 100. Correspondingly, two first piezoelectric cantilevers 200, two connecting members 300, and two support members 400 are disposed to be in a one-to-one correspondence with the two diaphragm assemblies 600, that is, the two first piezoelectric cantilevers 200 are connected in a one-to-one correspondence to the two connecting members 300, the two connecting members 300 are connected in a one-to-one correspondence to the two support members 400, and the two support members 400 are connected in a one-to-one correspondence to the two diaphragm assemblies 600, thereby achieving the driving of two diaphragm assemblies 600, improving the reliability of the dual-diaphragm loudspeaker, and prolonging its service life.

For example, the two diaphragm assemblies 600 are a first diaphragm assembly 620 and a second diaphragm assembly 630, respectively. One support member 400 is connected to the first diaphragm assembly 620, and the other support member 400 is connected to the second diaphragm assembly 630.

For example, as shown in FIG. 8, the dual-diaphragm loudspeaker in one or more embodiments is a symmetrical structure which, for example, is symmetrical in up and down directions shown in FIG. 8. The vibration direction of the first diaphragm assembly 620 is opposite to the vibration direction of the second diaphragm assembly 630, and when the two diaphragm assemblies vibrate in opposite directions, the vibrations will cancel each other out, thereby producing a better vibration-reducing effect and improving user experience.

In one or more embodiments, two second piezoelectric cantilevers 500 are also disposed. The two second piezoelectric cantilevers 500 are connected in a one-to-one correspondence to the two connecting members 300 to increase the driving area of the two diaphragm assemblies 600, thereby improving the sensitivity of the loudspeaker and enhancing the acoustic performance of the loudspeaker.

In one or more embodiments, the two first piezoelectric cantilevers 200 are disposed in upper and lower layers, the two second piezoelectric cantilevers 500 are disposed in upper and lower layers, and the first piezoelectric cantilever 200 and the second piezoelectric cantilever 500 corresponding to one diaphragm assembly 600 are disposed in the same layer.

The present disclosure has the following beneficial effects.

In the loudspeaker, the loudspeaker module and the electronic device provided by the present disclosure, the first free end of the first piezoelectric cantilever is connected to the connecting member, and the stiffness of the connecting member is less than the stiffness of the first piezoelectric cantilever. The support member is connected to the connecting member, and the support member is used for connecting the connecting member to the diaphragm assembly of the loudspeaker to transmit power. The position where the support member is connected to the connecting member is spaced from the position where the connecting member is connected to the first free end so that the first free end of the first piezoelectric cantilever is not directly connected to the support member, but is connected to the support member through the connecting member. The stiffness of the connecting member is less than the stiffness of the first piezoelectric cantilever so that the connecting member has a certain degree of elasticity compared to the first piezoelectric cantilever. The existence of the connecting member can prevent the amplitude of the diaphragm assembly from a drastic change in a short period of time so that the diaphragm assembly is not prone to damage when the connecting member drives the diaphragm assembly to vibrate through the support member, thereby improving the reliability of the loudspeaker and prolonging the service life of the loudspeaker.

One or more embodiments further provide a loudspeaker module including a housing and the loudspeaker described above. The loudspeaker module provided by this embodiment has high reliability.

The housing is provided with a sound outlet hole. The sound outlet hole enables the internal space of the housing to be in communication with the external space of the housing, and the loudspeaker is mounted in the internal space of the housing.

One or more embodiments further provide an electronic device including the loudspeaker described above or the loudspeaker module described above. The electronic device provided by one or more embodiments has high reliability.

The electronic device may include a mobile phone, a tablet personal computer, a laptop, a personal digital assistant (PDA), a camera, a personal computer, a notebook computer, an in-vehicle device, a wearable device, augmented reality (AR) glasses, an AR helmet, virtual reality (VR) glasses, a VR helmet, a fixed-line earpiece (a sound pick-up), a medical auxiliary device (for example, a hearing aid), various headphones (for example, a wireless or wired headphone), and other devices having loudspeakers. The embodiments of the present application do not impose any special limitations on the specific form of the above electronic device.

It is to be noted that the preceding are only preferred embodiments of the present disclosure and the technical principles used therein. It is to be understood by those skilled in the art that the present disclosure is not limited to the embodiments described herein. For those skilled in the art, various apparent modifications, adaptations, and substitutions can be made without departing from the scope of the present disclosure. Therefore, although the present disclosure has been described in detail through the preceding embodiments, the present disclosure is not limited to the preceding embodiments and may include other equivalent embodiments without departing from the concept of the present disclosure. The scope of the present disclosure is determined by the scope of the appended claims.

What is claimed is:

1. A loudspeaker, comprising:
a support frame;
a diaphragm assembly, wherein a periphery of the diaphragm assembly is fixedly connected to the support frame;
a first piezoelectric cantilever, wherein the first piezoelectric cantilever comprises a first fixed end and a first free end, the first fixed end is connected to the support frame, and the first free end is suspended inside the support frame;
a connecting member, wherein a first end of the connecting member is connected to the first free end, the other end of the connecting member extends in a direction facing away from the first free end, and a stiffness of the connecting member is less than a stiffness of the first piezoelectric cantilever; and
a support member, wherein the support member is connected to the connecting member and is used for being connected to the diaphragm assembly, and a position where the support member is connected to the connecting member is spaced from a position where the connecting member is connected to the first free end.

2. The loudspeaker according to claim 1, further comprising a second piezoelectric cantilever, wherein the second piezoelectric cantilever is disposed at a same layer as the first piezoelectric cantilever and comprises a second fixed end and a second free end, the second fixed end is connected to the support frame, and the second free end is suspended inside the support frame and spaced from the first free end;
a second end of the connecting member, disposed opposite to the first end of the connecting member, is connected to the second free end; and a position where the connecting member is connected to the second piezoelectric cantilever is spaced from the position where the support member is connected to the connecting member; and
the stiffness of the connecting member is less than a stiffness of the second piezoelectric cantilever.

3. The loudspeaker according to claim 2, wherein the first piezoelectric cantilever and the second piezoelectric cantilever are spaced in a first direction, and the support member is located between the first piezoelectric cantilever and the second piezoelectric cantilever in the first direction.

4. The loudspeaker according to claim 3, wherein one support member is provided in the loudspeaker, and a minimum distance between the support member and the first piezoelectric cantilever in the first direction is equal to a minimum distance between the support member and the second piezoelectric cantilever in the first direction.

5. The loudspeaker according to claim 3, wherein a plurality of support members are provided in the loudspeaker, and the plurality of support members are spaced in the first direction.

6. The loudspeaker according to claim 1, wherein a thickness direction of the connecting member is a same as a thickness direction of the first piezoelectric cantilever, one side of the connecting member in the thickness direction is connected to the first free end, and a thickness of the connecting member is less than a thickness of the first piezoelectric cantilever.

7. The loudspeaker according to claim 1, wherein a length of the connecting member in a second direction is equal to or less than a length of the first piezoelectric cantilever in the second direction.

8. The loudspeaker according to claim 1, wherein a protrusion is disposed on a surface of the diaphragm assembly facing the first piezoelectric cantilever, an avoidance structure matching the protrusion is disposed on a surface of the support member facing the diaphragm assembly, and the avoidance structure is used for avoiding the protrusion.

9. The loudspeaker according to claim 2, wherein a thickness direction of the connecting member is a same as a thickness direction of the first piezoelectric cantilever, one side of the connecting member in the thickness direction is connected to the first free end, and a thickness of the connecting member is less than a thickness of the first piezoelectric cantilever.

10. The loudspeaker according to claim 3, wherein a thickness direction of the connecting member is a same as a thickness direction of the first piezoelectric cantilever, one side of the connecting member in the thickness direction is connected to the first free end, and a thickness of the connecting member is less than a thickness of the first piezoelectric cantilever.

11. A loudspeaker module, comprising a housing and a loudspeaker, wherein the housing is provided with a sound outlet hole, the sound outlet hole enables an internal space of the housing to be in communication with an external space of the housing, and the loudspeaker is mounted in the internal space of the housing;
wherein the loudspeaker comprises:
a support frame;
a diaphragm assembly, wherein a periphery of the diaphragm assembly is fixedly connected to the support frame;
a first piezoelectric cantilever, wherein the first piezoelectric cantilever comprises a first fixed end and a first free end, the first fixed end is connected to the support frame, and the first free end is suspended inside the support frame;
a connecting member, wherein a first end of the connecting member is connected to the first free end, the other end of the connecting member extends in a direction facing away from the first free end, and a stiffness of the connecting member is less than a stiffness of the first piezoelectric cantilever; and
a support member, wherein the support member is connected to the connecting member and is used for being connected to the diaphragm assembly, and a position where the support member is connected to the connecting member is spaced from a position where the connecting member is connected to the first free end.

12. The loudspeaker module according to claim 11, further comprising a second piezoelectric cantilever, wherein the second piezoelectric cantilever is disposed at a same layer as the first piezoelectric cantilever and comprises a second fixed end and a second free end, the second fixed end is connected to the support frame, and the second free end is suspended inside the support frame and spaced from the first free end;
a second end of the connecting member, disposed opposite to the first end of the connecting member, is connected to the second free end; and a position where the connecting member is connected to the second piezoelectric cantilever is spaced from the position where the support member is connected to the connecting member; and
the stiffness of the connecting member is less than a stiffness of the second piezoelectric cantilever.

13. The loudspeaker module according to claim 12, wherein the first piezoelectric cantilever and the second piezoelectric cantilever are spaced in a first direction, and the support member is located between the first piezoelectric cantilever and the second piezoelectric cantilever in the first direction.

14. The loudspeaker module according to claim 13, wherein one support member is provided in the loudspeaker, and a minimum distance between the support member and the first piezoelectric cantilever in the first direction is equal to a minimum distance between the support member and the second piezoelectric cantilever in the first direction.

15. The loudspeaker module according to claim 13, wherein a plurality of support members are provided in the loudspeaker, and the plurality of support members are spaced in the first direction.

16. The loudspeaker module according to claim 11, wherein a thickness direction of the connecting member is a same as a thickness direction of the first piezoelectric cantilever, one side of the connecting member in the thickness direction is connected to the first free end, and a thickness of the connecting member is less than a thickness of the first piezoelectric cantilever.

17. The loudspeaker module according to claim 11, wherein a length of the connecting member in a second direction is equal to or less than a length of the first piezoelectric cantilever in the second direction.

18. The loudspeaker module according to claim 11, wherein a protrusion is disposed on a surface of the diaphragm assembly facing the first piezoelectric cantilever, an avoidance structure matching the protrusion is disposed on a surface of the support member facing the diaphragm assembly, and the avoidance structure is used for avoiding the protrusion.

19. An electronic device, comprising the loudspeaker according to claim 1.

20. An electronic device, comprising the loudspeaker according to the loudspeaker module according to claim 11.
